(19) United States
(12) Patent Application Publication
(10) Pub. No.: US 2026/0252843 A1
(43) Pub. Date: Aug. 27, 2026

(54) EMERGING TOPIC PREDICTION

(71) Applicant: Intuit Inc., Mountain View, CA (US)

(72) Inventors: Shon MENDELSON, Tel Aviv (IL); Kalev EDERY, Ramat Gan (IL); Yaaqov TAYEB, Tzur Hadasa (IL); Sigalit BECHLER, Bney-Zion (IL)

(73) Assignee: Intuit Inc., Mountain View, CA (US)

(21) Appl. No.: 19/065,870

(22) Filed: Feb. 27, 2025

(51) Int. Cl. G06N 3/042

(52) U.S. Cl. CPC G06N 3/042

(57) ABSTRACT

Systems and methods for predicting emerging topics are disclosed herein. An example method is performed by one or more processors of a computing system. The example method may include receiving a transmission over a communications network from a computing device associated with a user of the computing system. The example method may also include determining a most relevant domain for the user based on activity data associated with the user. The example method may also include selecting, for a prediction engine, a model trained to predict trends within the most relevant domain. The example method may also include obtaining, using the prediction engine in conjunction with the selected model, at least one predicted trend indicating an emerging topic within the most relevant domain. The example method may also include generating, for the user, at least one insight associated with the emerging topic.

### TECHNICAL FIELD

This disclosure relates generally to computer-based prediction, and specifically to training and using a model in conjunction with a prediction engine to predict emerging topics.

### DESCRIPTION OF RELATED ART

Detecting trends may include identifying patterns within large data sets that indicate changes of interest, such as timely opportunities, varying interests, activity over time, market developments, and the like. Many users, organizations, and applications depend on the timely discovery of meaningful trends to make strategic decisions, optimize resource allocation, and maintain a competitive edge. Traditionally, professional materials (e.g., industry reports and expert analyses) have been used as the primary source for detecting such trends.

However, conventional sources of information have many limitations. For instance, professional materials require time to prepare and thus often rely on outdated data. Furthermore, professional materials may not be supported by objective evidence, and thus may include biased and/or inaccurate conclusions about past and current conditions, thereby leading to biased and/or inaccurate predictions about future conditions. Accordingly, users, organizations, and applications that rely on such data may miss opportunities and inefficiently allocate their resources.

Furthermore, the complexity of the vast amount of data gathered in today’s technical world makes it impossible for any human analyst to manually extract meaningful insights from the data. Indeed, even conventional machine learning (ML)-based models struggle to accurately identify meaningful insights within a vast amount of data. For example, conventional models often generate meaningless and/or misleading insights when provided with unstructured or complex data sets, and thus cannot effectively reveal any true emerging trends.

Although many techniques have been developed in an attempt to improve the predictive abilities of ML-based models, there remains a significant need for advanced systems and methods that can more reliably detect emerging trends in a timely, objective, and scalable manner, such that users, organizations, and applications can effectively identify emerging trends and thus seize opportunities to more efficiently allocate their resources.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure can be implemented as a method for predicting emerging topics. An example method is performed by one or more processors of a computing system. The example method can include receiving a transmission over a communications network from a computing device associated with a user of the computing system, determining a most relevant domain for the user based on activity data associated with the user, selecting, for a prediction engine, a model trained to predict trends within the most relevant domain, obtaining, using the prediction engine in conjunction with the selected model, at least one predicted trend indicating an emerging topic within the most relevant domain, and generating, for the user, at least one insight associated with the emerging topic.

Another innovative aspect of the subject matter described in this disclosure can be implemented in a computing system for predicting emerging topics. An example system includes one or more processors and at least one memory coupled to the one or more processors and storing instructions that, when executed by the one or more processors, cause the system to perform operations. The operations can include receiving a transmission over a communications network from a computing device associated with a user of the computing system, determining a most relevant domain for the user based on activity data associated with the user, selecting, for a prediction engine, a model trained to predict trends within the most relevant domain, obtaining, using the prediction engine in conjunction with the selected model, at least one predicted trend indicating an emerging topic within the most relevant domain, and generating, for the user, at least one insight associated with the emerging topic.

Another innovative aspect of the subject matter described in this disclosure can be implemented as a non-transitory computer-readable medium storing instructions that, when executed by one or more processors of a system for predicting emerging topics, cause the system to perform operations. Example operations include receiving a transmission over a communications network from a computing device associated with a user of the computing system, determining a most relevant domain for the user based on activity data associated with the user, selecting, for a prediction engine, a model trained to predict trends within the most relevant domain, obtaining, using the prediction engine in conjunction with the selected model, at least one predicted trend indicating an emerging topic within the most relevant domain, and generating, for the user, at least one insight associated with the emerging topic.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example computing system, according to some implementations.

FIG. 2 shows an example process flow for predicting emerging topics, according to some implementations.

FIG. 3 shows an example process flow for determining a most relevant domain, according to some implementations.

FIG. 4 shows an example process flow for generating an insight associated with an emerging topic, according to some implementations.

FIG. 5 shows an example process flow for training a model.

FIG. 6 shows an illustrative flowchart depicting an example operation for predicting emerging topics, according to some implementations.

FIG. 7 shows an illustrative flowchart depicting an example operation for training a model, according to some implementations.

Like numbers reference like elements throughout the drawings and specification.

### DETAILED DESCRIPTION

As described above, detecting trends can involve identifying patterns in large data sets to reveal opportunities, shifting interests, and market developments, but traditional data sources (e.g., industry reports) are often outdated, subjective, and unreliable. Furthermore, the volume and complexity of modern data makes manual analysis impossible, and even conventional machine learning (ML) models struggle to extract accurate, meaningful insights. Accordingly, there is a significant need for an advanced, scalable, and objective system that can reliably detect emerging trends and enable optimum decision making and resource allocation.

Aspects of the present disclosure provide innovative systems and methods for predicting emerging topics using a computing system. Specifically, the various systems and methods disclosed herein use topic modeling and time-series prediction to automatically suggest focus areas and/or relevant upcoming trends, and can be deployed, for example, in an automated platform for providing users with real-time suggestions regarding their domain of interest so as to enable the users to make informed decisions about their resource (e.g., time, money, focus) allocations. By using advanced, scalable ML techniques to provide accurate, predictive insights in a personalized manner, aspects of the present disclosure may be used to address the problem of outdated, subjective, and labor-intensive trend detection.

For purposes of discussion herein, a “domain” refers to a primary area of interest or subject matter (or “parent topic” or “main topic”) relevant to a user, i.e., a broader category within which specific subtopics (or “topics”) may be identified and analyzed. In some instances, a domain may include any of a variety of fields, such as educational interests, travel destinations, personal interests, financial or business related subjects, healthcare-related subjects, consumer technology, hobbies, a particular product (e.g., books), or the like. For purposes of discussion herein, a “topic” refers to a distinct theme or subcategory (or “subtopic”) within a given domain. As a non-limiting example, within the domain of books, topics may include book genres such as historical fiction, mystery, and romance. As another non-limiting example, within the domain of technology, topics may include, for instance, artificial intelligence (AI), blockchain, and cybersecurity. For purposes of discussion herein, “activity data” includes any form of electronically gathered data related to what a user does with respect to a particular domain or topic, such as the user’s interactions, engagements, campaigns, endeavors, transactions, objectives, projects, actions, observations, metadata, or behavior related to a domain or topic. For purposes of discussion herein, an “insight” is an intelligently generated output derived from predictive analysis with respect to one or more particular topics within one or more particular domains, thereby providing a user with a meaningful recommendation or guidance with respect to the particular topic(s) or domain(s). For purposes of discussion herein, a “level of success” refers to a quantifiable measure that reflects a degree to which a given topic or domain achieves (or is predicted to achieve) desired outcomes over a defined time period, where the measure is derived from aggregated user activity data based on one or more success metrics (e.g., clickthrough rate (CTR), conversion rate, revenue generated, profit earned, engagement rate, or other suitable indicators) that are relevant to the given topic or domain, i.e., a level of success may refer to an observed performance (through historical time-series analyses) and/or a predicted performance (via forecasting models trained on aggregated data).

A computing system may be used to perform the various operations of the systems and methods disclosed herein. In accordance with the innovative techniques disclosed herein, the computing may receive a transmission (e.g., from a user’s device) and determine a most relevant domain for the user based on analyzing activity data associated with the user. Upon identifying the most relevant domain, the system may select a model from a plurality of models trained to identify patterns and make predictions within particular domains. Specifically, the computing system selects the model that is specifically trained to predict trends within the most relevant domain. The computing system then uses the selected model in conjunction with a prediction engine (i.e., a component of the system that applies advanced statistical and machine learning techniques) to predict at least one trend related to the most relevant domain. Thereafter, the computing system generates and provides at least one insight related to the emerging topic based on the predicted trend. For instance, the insight may help the user stay informed about upcoming trends and make strategic decisions related to the most relevant domain. In these and other manners, the computing system automatically analyzes user data to determine a primary area of interest, applies a specialized model to predict future trends within the primary area of interest, and provides tailored insights related to the predicted future trends.

The computing system described herein provides several technical benefits over conventional solutions for predicting emerging topics. By combining topic modeling and time-series prediction to automatically suggest domain‐specific focus areas, the system generates targeted recommendations that facilitate efficient resource allocation and informed planning. By integrating clustering and topic modeling techniques to identify meaningful subjects in user data, the system reveals underlying data patterns that empower users to prioritize strategies effectively. By forecasting upcoming trends and emerging topics using time-series prediction models, the system anticipates changes within a domain or topic and provides actionable trend forecasts to inform strategic planning. By predicting trends and seasonality based on domain or topic behavior, the system generates reliable forecasts that enable efficient resource allocation and a strategic focus on evolving domain dynamics. By leveraging long-term engagements, the system synthesizes extensive data to provide comprehensive insights into domain cycles, detect emerging trends, and support more informed decision-making.

Aspects of the present disclosure address the technical problem of reliably detecting emerging trends within vast, unstructured, and complex data sets, which did not exist in the pre-Internet world before the invention of high-speed networking, advanced computing systems, big data processing technologies, and ML models. Accordingly, the problem addressed by the aspects of the present disclosure is rooted in and arises in computer technology, and the present disclosure describes a solution to the technical problem. In particular, the Specification and the claims provide a method of predicting emerging topics using topic modeling and time-series prediction, which includes automatically analyzing large-scale, unstructured datasets, identifying meaningful patterns, and providing real-time suggestions regarding emerging trends. Aspects of the present disclosure provide many practical applications by solving a problem rooted in and arising in computer technology and providing improvements to computer functionality. As some non-limiting examples, the computing system 100 described herein may effectively harness vast amounts (e.g., gigabytes, terabytes, petabytes, exabytes, or more) of unstructured rows of activity data using the computer-based innovations described herein to enable a student user to make strategic decisions regarding courses to enroll in for career development, to enable a hobbyist user to make strategic decisions regarding skills to learn for personal growth, to enable a parent user to make strategic decisions regarding extracurricular activities for their child’s development, to enable a traveler user to make strategic decisions regarding destinations to visit for cultural enrichment, to enable a manager user to detect emerging trends in the market for a marketing campaign, to enable a retailer user to make strategic decisions regarding sub-products to focus on, to enable an employer user to make strategic decisions regarding employees to hire, to enable a service provider user to make strategic decisions regarding services to expand on, and the like.

Furthermore, aspects of the subject matter disclosed herein are not an abstract idea, such as a mere mental process that can be performed solely by the human mind. For example, the human mind is incapable of processing and analyzing vast amounts of unstructured data in real time to extract topics through complex topic modeling, nor can it perform dynamic time-series predictions to reliably forecast emerging trends. While a human can manually review a small dataset in an attempt to identify patterns, the present disclosure leverages computationally intensive techniques (e.g., processing hundreds of thousands of data points, identifying intricate patterns, and continuously updating predictions using advanced ML techniques and statistical models in at least near real-time), thereby achieving results far beyond human capability. Moreover, the subject matter disclosed herein is not directed to organizing human activity or any conventional economic practice, but rather provides a technical solution to a problem that requires sophisticated computer technology. Specifically, various implementations of the present disclosure provide specific inventive steps to automate the detection and prediction of emerging topics by integrating topic modeling with time-series prediction, thereby improving the accuracy, scalability, and timeliness of data analysis in modern computer-based systems operating in dynamic and data-intensive environments.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

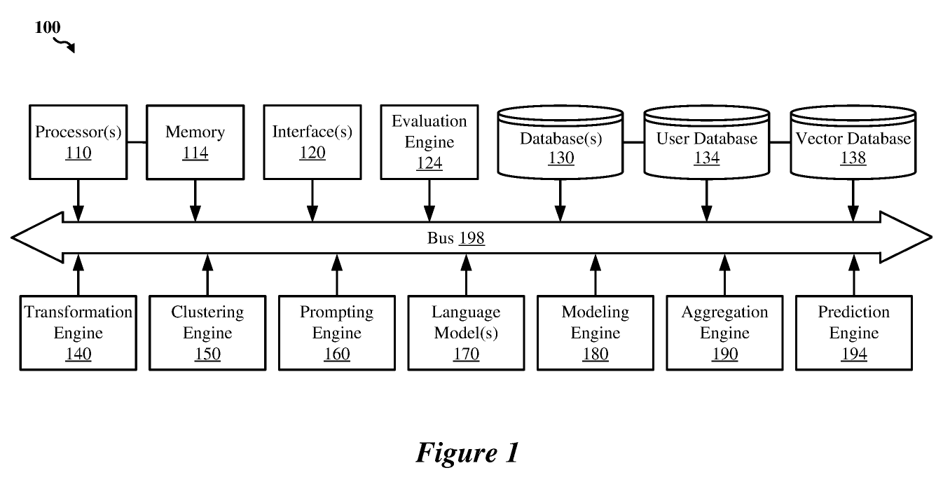

FIG. 1 shows an example computing system 100, according to some implementations. Various aspects of the computing system 100 disclosed herein are generally applicable for training models to predict emerging topics and/or for using a prediction engine in conjunction with the trained models to predict emerging topics in real-time. The computing system 100 includes a combination of one or more processors 110, a memory 114 coupled to the one or more processors 110, one or more interfaces 120, an evaluation engine 124, one or more databases 130, a user database 134, a vector database 138, a transformation engine 140, a clustering engine 150, a prompting engine 160, one or more language models (LMs) 170, a modeling engine 180, an aggregation engine 190, and/or a prediction engine 194. In some implementations, the computing system 100 does not include one or more components illustrated in FIG. 1. For example, in a training-specific implementation, the computing system 100 may not include at least one of the interface 120, the evaluation engine 124, or the prediction engine 194. For another example, in an inference-specific implementation, the computing system 100 may not include at least one of the transformation engine 140, the clustering engine 150, the prompting engine 160, the LM 170, or the modeling engine 180. In some implementations, the various components of the computing system 100 are interconnected by at least a data bus 198. In some other implementations, the various components of the computing system 100 are interconnected using other suitable signal routing resources.

The processor 110 includes one or more suitable processors capable of executing scripts or instructions of one or more software programs stored in the computing system 100, such as within the memory 114. In some implementations, the processor 110 includes a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 110 includes a combination of computing devices, such as a combination of a DSP and a microprocessor, a plurality of microprocessors, one or more microprocessors in conjunction with a DSP core, or any other suitable configuration. In some implementations, the processor 110 incorporates one or more hardware accelerators for processing a large amount of data and/or one or more artificial intelligence (AI) accelerators for accelerating AI and machine learning (ML)-based operations, such as one or more graphics processing units (GPUs), one or more tensor processing units (TPUs), one or more neural processing units (NPUs), a wafer-scale integration (WSI) architecture, or the like. For example, the processor 110 may use hardware-based TPUs to process and/or adjust millions, billions, or trillions of artificial neural network (ANN) parameters within seconds, milliseconds, or microseconds.

The memory 114, which may be any suitable persistent memory (such as non-volatile memory or non-transitory memory) may store any number of software programs, executable instructions, machine code, algorithms, and the like that can be executed by the processor 110 to perform one or more corresponding operations or functions. In some implementations, hardwired circuitry is used in place of, or in combination with, software instructions to implement aspects of the disclosure. As such, implementations of the subject matter disclosed herein are not limited to any specific combination of hardware circuitry and/or software.

One or more input/output (I/O) interfaces (e.g., the interface 120) may be used for transmitting or receiving (e.g., over a communications network, such as the Internet or an intranet) transmissions, input data, and/or instructions to or from a computing device (e.g., associated with a user of the system 100), outputting data (e.g., over the communications network) to the computing device, or the like. The interface 120 may also be used to transmit communications to the user’s computing device. The interface 120 may also be used to provide or receive other suitable information, such as computer code for updating one or more programs stored on the computing system 100, internet protocol requests and results, or the like. An example interface includes a wired interface or wireless interface to the Internet or other means to communicably couple with user devices or any other suitable devices. In an example, the interface 120 includes an interface with an ethernet cable to a modem, which is used to communicate with an internet service provider (ISP) directing traffic to and from user devices and/or other parties. In some implementations, the interface 120 is also used to communicate with another device within the network to which the computing system 100 is coupled, such as a smartphone, a tablet, a personal computer, or other suitable electronic device. In various implementations, the interface 120 includes a display, a speaker, a mouse, a keyboard, or other suitable input or output elements that allow interfacing with the computing system 100 by a local user or moderator.

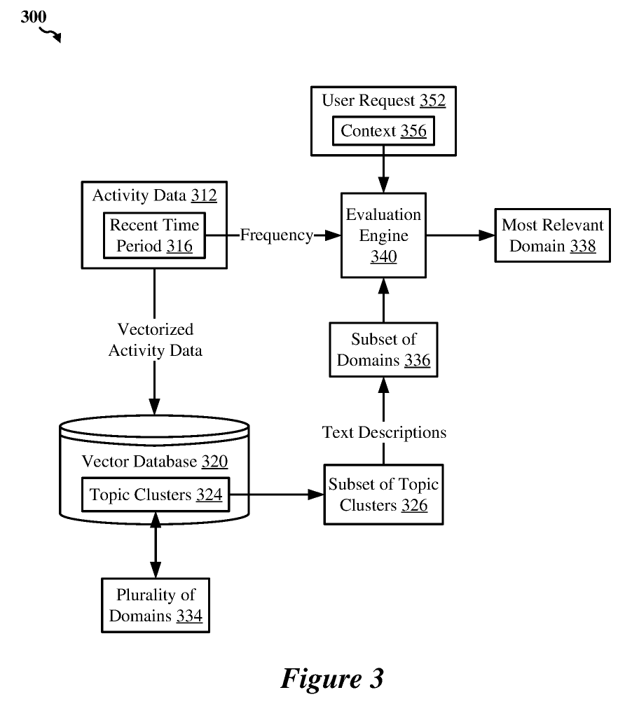

The evaluation engine 124 may be used to determine a most relevant domain for a user based on activity data, as described at least with respect to FIG. 3.

The database 130 may store data associated with the computing system 100, such as models, engines, topics, domains, transmissions, metadata, trends, insights, among other suitable information. In various implementations, the database 130 may also store datasets, features, instances, attributes, values, variables, scores, degrees or measures (or other suitable quantities), decision trees, engines, classifiers, predictions, formulas, metrics, input, output, queries, responses, requests, application information, instructions, user data, configurations, thresholds, data associated with attacks and mitigation techniques, data associated with changes, events, change data capture (CDC) information, event bus (EB) information, filters, data assets, preferences, priorities, timestamps, models, algorithms, modules, engines, user information, historical data, recent data, current or real-time data, files, plugins, arrays, tags, queries, feedback, formats, features, among other suitable information. In various implementations, the database 130 stores data associated with artificial neural network (ANN) models, such as the models themselves, untrained models, pretrained models, tuned models, aligned models, reward models, neural network (NN) parameters (e.g., weights, biases, tensors, parameters), architectures (e.g., layer descriptions, neurons, activation functions, overall structures), training data and related information (e.g., statistics, distribution, size, preprocessing steps, training data, text corpora, tuning data, alignment data, alignment data snapshots, alignment preferences, metric logs, accuracies, loss functions and values), hyperparameters (e.g., learning rates, batch sizes, numbers of epochs), evaluation results (e.g., performance metrics and models, validation data, test sets, benchmark scores, thresholds, receiver operating characteristic (ROC) curves, confusion matrices), versioning information (e.g., iterations, updates), metadata and documentation (e.g., usage instructions, authors), deployment configurations (e.g., settings for deploying models in different environments), monitoring data (e.g., real-time or periodic tracking performance in production), or any other suitable data related to ANN models. In various implementations, the database 130 may store data in one or more cloud object storage services, such as one or more Amazon Web Services (AWS)-based Simple Storage Service (S3) buckets. In various implementations, the database 130 incorporates one or more aspects of a database management system (DBMS) or a relational DBMS (RDBMS). In various implementations, the data may be stored in one or more JavaScript Object Notation (JSON) files, comma-separated values (CSV) files, or any other suitable data objects for processing by the computing system 100. In some implementations, the data may be stored in one or more Structured Query Language (SQL) compliant datasets for filtering, querying, and sorting, or any other suitable format for processing by the computing system 100. In various implementations, the database 130 includes a relational database capable of presenting information as datasets in tabular form and capable of manipulating the datasets using relational operators.

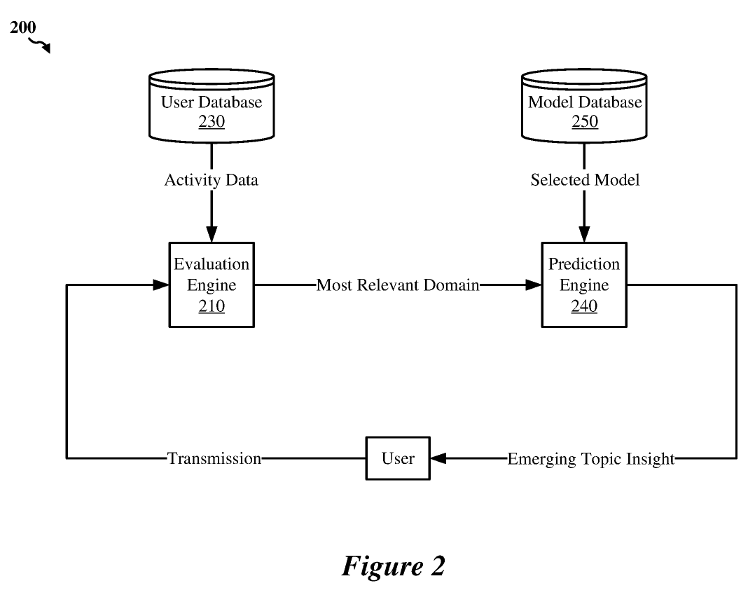

The user database 134 may store data associated with users, such as user data, activity data, textual representations, or the like, as described at least with respect to FIGS. 2–3 and 5. In some implementations, the user database 134 is one of a plurality of databases managed by the database 130. The user database 134 may incorporate one or more aspects of, for example, at least of a relational database (e.g., MySQL, PostgreSQL, SQLite), or another suitable database for structured user data management.

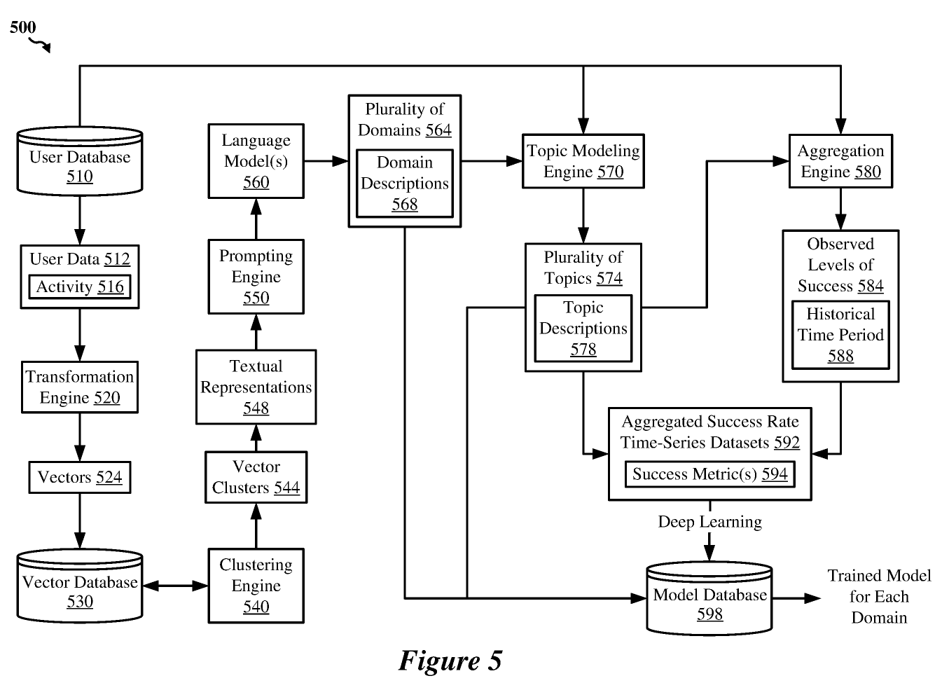

The vector database 138 may store data associated with vectors, such as the vectors (or “numerical embeddings”) themselves, vector (or “topic”) clusters, or the like, as described at least with respect to FIGS. 3 and 5. In some implementations, the vector database 138 is one of a plurality of databases managed by the database 130. The vector database 138 may incorporate one or more aspects of, for example, at least one of a vector search engine or another suitable database for high-dimensional vector similarity search.

The transformation engine 140 may be used to transform activity data into vectors, as described at least with respect to FIG. 5.

The clustering engine 150 may be used to identify vector clusters in the vector database 138, as described at least with respect to FIG. 5.

The prompting engine 160 may be used to generate prompts for the one or more LMs 170, as described at least with respect to FIGS. 3 and 5.

The one or more LMs 170 may be any suitable generative AI model trained on a large corpus of text to generate written responses, answer questions, translate language, and/or assist with various natural language processing (NLP)-based tasks. In various implementations, the LM 170 may be a large language model (LLM) or a multimodal large language model (MLLM). In various implementations, the LM 170 is integrated directly into one or more applications (not shown for simplicity) associated with the computing system 100 or as a separate service. For example, the one or more applications may each include one or more interconnected modules or components that interact with each other to perform one or more functions or tasks, such as providing a desired functionality to a user (e.g., predicting emerging topics for the user in real-time with the user transmitting a request to the computing system 100). In various implementations, the application integrates one or more aspects of ML, deep learning (DL), or AI to provide predictive capabilities, personalized recommendations, decision-making automation, or the like. In various implementations, the application may have a monolithic architecture, a microservices architecture including a plurality of services coupled via one or more application programming interfaces (APIs), and/or a distributed architecture across a plurality of processes and/or machines and network protocols. In various implementations, the application may integrate with one or more external systems or services (e.g., via APIs) to enable the application to interact with one or more third-party gateways, services, or platforms. In various implementations, the application may be deployed on a variety of hardware platforms, mobile devices, embedded systems, or cloud servers, and may incorporate one or more CPUs, GPUs, FPGAs, sensors, or other specialized hardware and/or AI-based accelerators to optimize performance for specific tasks. Some non-limiting example application tasks may include data processing, data analytics, fraud detection, transaction analysis, model simulation, static communication, real-time communication, collaboration, project management, entertainment, streaming, gaming, or any other suitable application task. In various implementations, the application may be developed based on a variety of programming languages and frameworks, such as Python, Node.js, Java, React.js, Angular, Flutter, or another suitable language or framework. In various implementations, the application is hosted on a cloud platform (e.g., Amazon Web Services (AWS) or Azure) and/or an on-premise infrastructure (e.g., the database 130). In various implementations, the application incorporates one or more security mechanisms, such as an authentication mechanism (e.g., multi-factor authentication (MFA)), data encryption (e.g., in transit and at rest), audit logging, an AI firewall, or the like. In various implementations, the LM 170 may receive requests (e.g., from the one or more applications), and may provide responses (e.g., to the one or more applications). In various implementations, the LM 170 may be embedded within at least one of the applications, the LM 170 may be hosted externally (e.g., accessed via APIs or cloud-based services) and in direct communication with at least one of the applications, or the LM 170 may be hosted externally and in indirect communication with the at least one application (e.g., via an intermediate service, application, or system, such as an AI firewall). In various implementations, the LM 170 may use various AI accelerators to process vast amounts of textual data (e.g., from the Internet), integrate with one or more ANNs with millions to billions or even trillions of weights or parameters, use self-supervised and/or semi-supervised training methods, incorporate one or more aspects of the transformer architecture and/or mixture of experts (MoE), operate in part based on predicting a next token or word from an input, perform various NLP tasks, and/or include multiple layers of transformer blocks configured using aspects of deep learning to recognize and generate language patterns by processing the vast amounts of textual data using the billions or even trillions of parameters or weights. Example LMs may include OpenAI’s ChatGPT, Google’s Gemini, Meta’s LLaMa, BigScience’s BLOOM, Baidu’s Ernie, Anthropic’s Claude, or another suitable type of ML-based neural network compatible with prompting techniques.

The modeling engine 180 may be used to identify topics within domains, as described at least with respect to FIG. 5.

The aggregation engine 190 may be used to determine observed levels of success for topics within domains based on related user activity over a historical time period and perform aggregated success rate time-series analyses for topics based on observed levels of success, as described at least with respect to FIG. 5.

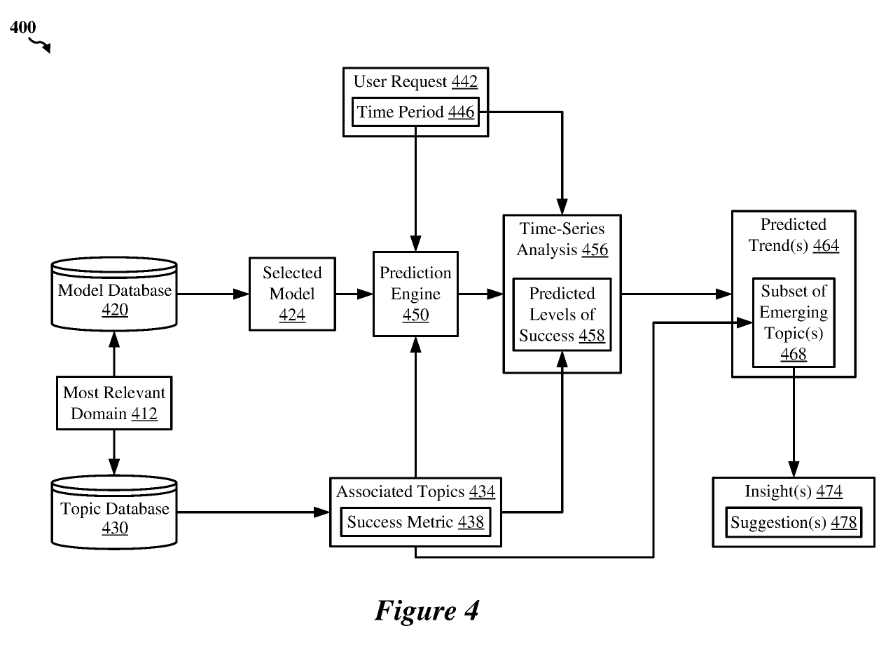

The prediction engine 194 may be used to obtain predicted trends indicating emerging topics within domains, generate insights for users associated with emerging topics, and perform, in real-time in conjunction with a selected model, a time-series analysis for associated topics over a relevant time period, as described at least with respect to FIGS. 2 and 4.

The evaluation engine 124, the database 130, the user database 134, the vector database 138, the transformation engine 140, the clustering engine 150, the prompting engine 160, the LM 170, the modeling engine 180, the aggregation engine 190, and the prediction engine 194 are implemented in software, hardware, or a combination thereof. In some implementations, any one or more of the evaluation engine 124, the database 130, the user database 134, the vector database 138, the transformation engine 140, the clustering engine 150, the prompting engine 160, the LM 170, the modeling engine 180, the aggregation engine 190, or the prediction engine 194 is embodied in instructions that, when executed by the processor 110, cause the computing system 100 to perform operations. In various implementations, the instructions of one or more of said components and/or the interface 120 are stored in the memory 114, the database 130, or a different suitable memory, and are in any suitable programming language format for execution by the computing system 100, such as by the processor 110. It is to be understood that the particular architecture of the computing system 100 shown in FIG. 1 is but one example of a variety of different architectures within which aspects of the present disclosure can be implemented. For example, in some implementations, components of the computing system 100 are distributed across multiple devices, included in fewer components, and so on. While the below examples related to training models to predict emerging topics and/or using a prediction engine in conjunction with the trained models to predict emerging topics in real-time are described with reference to the computing system 100, other suitable system configurations may be used.

FIG. 2 shows an example process flow 200 for predicting emerging topics, according to some implementations, and may be performed by one or more processors of a computing system, such as the computing system 100 described with respect to FIG. 1. The example process flow 200 shows an evaluation engine 210, a user database 230, a prediction engine 240, and a model database 250, which may be examples of the evaluation engine 124, the user database 134, the prediction engine 194, and the database 130 described with respect to FIG. 1, respectively.

The example process flow 200 starts with the evaluation engine 210 receiving a transmission from a user of the computing system 100. In some implementations, the transmission is received over a communications network (e.g., the Internet or an intranet) from a computing device associated with the user, such as via the interface 120 described with respect to FIG. 1. The evaluation engine 210 may then obtain activity data associated with the user from the user database 230. The example process flow 200 continues with the evaluation engine 210 determining a most relevant domain for the user based on the activity data. The computing system 100 may then provide the most relevant domain to the prediction engine 240 and select, for the prediction engine 240, a model trained to predict trends within the most relevant domain. The selected model may be obtained from the model database 250. The computing system 100 may then obtain, using the prediction engine 240 in conjunction with the selected model, at least one predicted trend indicating an emerging topic within the most relevant domain. The example process flow 200 continues with the prediction engine 240 generating, for the user, at least one insight associated with the emerging topic.

FIG. 3 shows an example process flow 300 for determining a most relevant domain, according to some implementations, and may be performed by one or more processors of a computing system, such as the computing system 100 described with respect to FIG. 1. The example process flow 300 shows a vector database 320 and an evaluation engine 340, which may be examples of the vector database 138 and the evaluation engine 210, respectively, described with respect to FIG. 1 and FIG. 2.

The example process flow 300 starts with obtaining activity data 312, which may be an example of the “activity data” described with respect to FIG. 2. In some implementations, the activity data 312 is retrieved from a user database (e.g., the user database 230) responsive to receiving a transmission (e.g., the transmission described with respect to FIG. 2). In some instances, the activity data 312 is associated with a recent time period 316. For example, the recent time period 316 may be 90 days, and the activity data 312 may be an extracted subset of a user’s activity data that occurred within the most recent 90 days.

The example process flow 300 continues with vectorizing the activity data 312. As some non-limiting examples, vectorizing the activity data 312 may incorporate one or more aspects of a dimensionality reduction technique, a feature embedding technique, or a sequence encoding technique. The vector database 320 may include a plurality of topic clusters 324 that each correspond to one of a plurality of domains 334, as described with respect to FIG. 5.

The example process flow 300 continues with identifying, in the vector database 320, ones of the topic clusters 324 that are most similar to the vectorized activity data. In some implementations, the identifying includes querying the vector database 320 with the vectorized activity data and determining similarities between the queried vectors and the stored vectors using a suitable distance metric. The most similar clusters may be identified as a subset of topic clusters 326. In various aspects, identifying the subset of topic clusters 326 is based on a technique incorporating at least one of a similarity metric, (a maximum value of) a cosine similarity, a Euclidean distance, a k nearest neighbor, a centroid, a similarity threshold, or an approximate nearest neighbor (ANN).

The example process flow 300 continues with identifying a subset of domains 336 corresponding to the subset of topic clusters 326. Identifying the subset of domains 336 may be based on a text description corresponding to each of the subset of topic clusters 326. As a non-limiting example, a top four topic clusters quantitatively identified as most similar to the vectorized activity data may be associated with text descriptions of “books,” “DVDs,” “CDs,” and “comics,” and thus the subset of domains 336 may be identified as “books,” “DVDs,” “CDs,” and “comics.” The subset of domains 336 and the user’s text-based activity data 312 (e.g., for the recent time period 316) may be provided to the evaluation engine 340.

In some implementations, the example process flow 300 continues with the evaluation engine 340 determining which of the subset of domains 336 appears most frequently within the user’s activity data 312 that is associated with the recent time period 316. In such implementations, a most relevant domain 338 of the plurality of domains 334 may be selected as a most frequently appearing one of the subset of domains 336. In various implementations, the determining may incorporate one or more aspects of a machine learning (ML) technique, a statistical analysis technique, a pattern recognition technique, or a natural language processing (NLP) technique.

In some other implementations, the evaluation engine 340 may use a language model (LM) (e.g., one of the LMs 170 described with respect to FIG. 1) to determine a most relevant domain 338 for the user based on the activity data 312 and the subset of domains 336. The most relevant domain 338 may be an example of the “most relevant domain” described with respect to FIG. 2. For instance, the evaluation engine 340 may feed the activity data 312 for the recent time period 316 and the subset of domains 336 to the LM 170, and prompt the LM 170 (e.g., using the prompting engine 160) to select the most relevant domain 338 among the subset of domains 336 based on the fed data. In some instances, the evaluation engine 340 may determine that the user’s activity is most frequently associated with a first domain across all of the user’s history and that, in a recent time period (e.g., the most recent three months), the user’s activity has been most frequently associated with a second domain different than the first domain. In such instances, the evaluation engine 340 may determine that the second domain is the most relevant domain 338 as it would be most suitable for identifying “emerging trends” relevant to the user.

In some instances, a user request 352 (which may be an example portion of the “transmission” described with respect to FIG. 2) is provided to the evaluation engine 340, and a context 356 of the user request 352 may be determined using, for example, the LM 170. In such instances, the evaluation engine 340 may determine the most relevant domain 338 further based on the context 356. As a non-limiting example, if the user request 352 includes a query stating “Which genre of music should I focus on next season?,” the context 356 may indicate, in part, “music,” and thus, the evaluation engine 340 may be more likely to determine that “DVDs” or “CDs” is the most relevant domain 338 (e.g., rather than “books” or “comics”) even when activity data related to “books” or “comics” appears within the user’s activity data more frequently than “DVDs” or “CDs.” As another non-limiting example, the user request 352 may include a command stating “Find me emerging trends related to my business.,” and thus the context 356 may simply indicate “user’s business.” In such instances, the evaluation engine 340 may identify a number of domains related to the user’s activity and identify the most relevant domain 338 based on a domain associated with a highest frequency of activity.

FIG. 4 shows an example process flow 400 for generating an insight associated with an emerging topic, according to some implementations, and may be performed by one or more processors of a computing system, such as the computing system 100 described with respect to FIG. 1. The example process flow 400 shows a model database 420, a topic database 430, and a prediction engine 450, which may be examples of the model database 250, the database 130, and the prediction engine 240, respectively, described with respect to FIG. 1 and FIG. 2.

The example process flow 400 starts with obtaining a most relevant domain 412, which may be an example of the most relevant domain 338 described with respect to FIG. 3. The model database 420 may store a plurality of models that are each compatible with the prediction engine 450, where each of the models is trained to predict trends within a different domain, as described with respect to FIG. 5. Thus, the model database 420 may be queried with the most relevant domain 412 to determine which of the plurality of models matches or is most relevant to (e.g., as deemed by a language model (LM), such as one of the LMs 170 described with respect to FIG. 1) the most relevant domain 412. As a non-limiting example, the most relevant domain 412 may be “books,” metadata associated with a particular one of the models may indicate that the particular model is trained to predict trends related to “books,” and thus the particular model may be selected as an exact match for the most relevant domain 412, i.e., a selected model 424. The selected model 424 may be an example of the “selected model” described with respect to FIG. 2.

The example process flow 400 continues with querying the topic database 430 with the most relevant domain 412. In some implementations, the topic database 430 stores a set of topics for each of the plurality of domains, as described with respect to FIG. 5. As a non-limiting example, the most relevant domain 412 may be “books,” and an associated set of topics 434 may be extracted from the topic database 430 that includes a “science fiction” topic, a “history” topic, a “romance” topic, and a “comedy” topic. The most relevant domain 412 may also be associated with a success metric 438 deemed suitable for evaluating a success of the associated topics 434 over time. As a non-limiting example, the success metric 438 may be a clickthrough rate (CTR), and the selected model 424 may be trained using deep learning (DL) in conjunction with historical time-series data indicating a historical CTR for each of the associated topics 434 over time. In various other implementations, the success metric is associated with at least one of revenue generated, profit earned, a conversion rate, a user satisfaction, a user churn, a return on investment (ROI), a market share, website traffic, an engagement rate, a number of downloads, a number of likes, a number of active users, a weight loss, a weight gain, a number of steps taken, a quality of sleep quality, a debt-to-income ratio, a savings rate, a number of books read, an amount of time spent learning, or any other suitable measure that can quantify progress towards a goal over time based on related activity data.

In some instances, a user request 442 (which may be an example portion of the user request 352 described with respect to FIG. 3) is provided to the prediction engine 450, and a time period 446 relevant to the user request 442 may be determined using, for example, the LM 170. As a non-limiting example, if the user request 442 includes a query stating “Are there any books I should stock up on for spring break?,” the LM 170 may perform an Internet search (and/or solicit a follow-up input from the user) to determine when spring break occurs in the user’s area (e.g., the next March 24–March 28) and then determine that the time period 446 should include at least March 24–March 28.

The example process flow 400 continues with the prediction engine 450 performing, in conjunction with the selected model 424, a time-series analysis for the associated topics 434 over at least the time period 446. The prediction engine 450 may output the results as a time-series analysis 456 including predicted levels of success 458 indicating, for each of the associated topics 434, a predicted level of success for the success metric 438 over at least the time period 446. As a non-limiting example, the predicted levels of success 458 may include a predicted CTR for each of the “science fiction” book topic, the “history” book topic, the “romance” book topic, and the “comedy” book topic for at least the next March 24–March 28.

The example process flow 400 continues with generating one or more predicted trends 464 based on the time-series analysis 456. As a non-limiting example, the computing system 100 may determine that the “comedy” book topic has a highest predicted CTR for the next March 24–March 28, and thus the computing system 100 may select a subset of the associated topics 434 as emerging topics 468, where the subset of emerging topics 468 includes the “comedy” book topic. As another non-limiting example, the computing system 100 may determine that the “comedy” book topic and the “romance” book topic each have a predicted CTR greater than a threshold (e.g., 5%) for the next March 24–March 28, and thus the computing system 100 may select the “comedy” book topic and the “romance” book topic for inclusion in the subset of emerging topics 468.

The example process flow 400 continues with generating at least one insight 474 associated with the subset of emerging topics 468. The insight 474 may be an example of the “emerging topic insight” described with respect to FIG. 1. In some implementations, the at least one insight 474 includes one or more suggestions 478 for the user to pursue activity related to the subset of emerging topics 468. As a non-limiting example, the subset of emerging topics 468 may include the “comedy” book topic and the “romance” book topic, and thus the insights 474 may include suggestions 478 for the user to pursue activity related to comedy books and romance books for the next March 24–March 28. As another non-limiting example, the computing system 100 may determine that the “history” book topic has a predicted CTR significantly lower than average for the next March 24–March 28 (e.g., more than 30% below average as compared with other seasons), and thus one of the insights 474 may include a suggestion 478 for the user to refrain from focusing on activity related to the “history” book topic during the upcoming March 24–March 28.

In some instances not shown for simplicity, the suggestions 478 may be provided to the LM 170, and the LM 170 may generate a customized insight 474 for the user. For this non-limiting example, if the user’s query was “Are there any books I should stock up on for spring break?,” the customized insight 474 may include a suggestion 478 stating that “We suggest you have plenty of comedy books and romance books available during spring break, and you may wish to display the additional comedy and romance books in place of your history books.”

The at least one insight 474 and/or the at least one suggestion 478 may be output to a user (e.g., via the interface 120 described with respect to FIG. 1) in at least near real-time with receiving a transmission (e.g., including the user request 442) from the user.

FIG. 5 shows an example process flow 500 depicting an example operation for training a model, according to some implementations, and may be performed by one or more processors of a computing system, such as the computing system 100 described with respect to FIG. 1. The example process flow 500 shows a user database 510, a transformation engine 520, a vector database 530, a clustering engine 540, a prompting engine 550, one or more language models (LMs) 560, a topic modeling engine 570, an aggregation engine 580, and a model database 598, which may be examples of the user database 230, the transformation engine 140, the vector database 320, the clustering engine 150, the prompting engine 160, the LMs 170, the modeling engine 180, the aggregation engine 190, and the model database 420, respectively, described with respect to FIGS. 1–4.

The example process flow 500 starts with retrieving, from the user database 510, user data 512 including activity 516. The activity 516 may include user activity data for a plurality (e.g., thousands, millions, billions) of users over time (e.g., for the past year, three years, five years, ten years, twenty years, or the like). The activity data 312 described with respect to FIG. 3 may be an example of a portion of the activity 516 associated with one of the plurality of users. In some implementations, the activity 516 includes a plurality (e.g., tens of thousands, millions, billions, or more) of rows that each indicate an activity performed by a user or any interaction, engagement, campaign, endeavor, transaction, objective, project, action, observation, metadata, or behavior associated with a user.

The example process flow 500 continues with the transformation engine 520 transforming at least the activity 516 into vectors 524 and storing the vectors in the vector database 530. In some implementations, transforming the activity 516 includes vectorizing each of the plurality of rows into a corresponding numerical embedding. In some instances. the activity 516 is transformed using a pretrained transformer model, such as MiniLM-L6-V2 or another suitable pretrained, slim (i.e., lightweight) text embedding model that can efficiently generate accurate embeddings. Storing the vectors in the vector database 530 may incorporate one or more aspects of, for example, at least one of an approximate nearest neighbor (ANN) indexing technique, a vector similarity search technique (e.g., cosine similarity or Euclidean distance), or another suitable vector storage technique suitable for storing a large number of embeddings for efficient retrieval.

The example process flow 500 continues with the clustering engine 540 identifying a plurality of vector clusters 544 in the vector database 530. For instance, each of the vector clusters 544 may represent a numerical grouping of user data related to a same domain. Identifying the vector clusters 544 may incorporate one or more aspects of, for example, at least one of an unsupervised clustering technique (e.g., k-means, DBSCAN, hierarchical clustering), a spectral clustering technique, or a density-based clustering technique.

The example process flow 500 continues with identifying a representative subset of vectors for each vector cluster 544. For instance, the representative subset of vectors for a given vector cluster 544 may include a k nearest to center (e.g., the centroid of the given vector cluster 544) embeddings for the given vector cluster 544. In such instances, a “main topic” or “domain” of the given vector cluster 544 may be determined based on the embeddings that have the maximum cosine similarity compared to the centroid of the given vector cluster 544. In various implementations, the representative subsets of vectors and/or the main topic may be identified based on, for example, at least one of a distance-based criteria (e.g., ranking vectors by proximity to a cluster centroid), a medoid selection technique, a k-medoids technique, a silhouette score technique, or another suitable clustering metric technique. Thereafter, textual representations 548 may be obtained for each of the representative vectors, such as based on the pre-transformed activity 516 associated with the representative subsets of vectors.

The example process flow 500 continues with grouping the textual representations 548 based on their corresponding vector clusters 544. For each respective vector cluster of the vector clusters 544 that has not yet been identified with a main topic (which may be all of the vector clusters 544 in some instances), the prompting engine 550 may generate a prompt for the LM 560 including an instruction to identify a main topic associated with the group of textual representations 548 corresponding to the respective vector cluster. In this manner, the prompting engine 550 may be used in conjunction with the LM 560 to generate a domain description for the vector clusters 544 based on the corresponding textual representations 548. At least one of the generated description or an identifier (ID) generated (e.g., by the LM 560) based on the description may be assigned to each remaining vector cluster 544. In these manners, a text-based domain and description is determined for each of the vector clusters 544 based on the user data 512, thereby identifying a plurality of domains 564 with corresponding domain descriptions 568. The plurality of domains 564 may be an example of the plurality of domains 334 described with respect to FIG. 3. The plurality of domains 564 and their corresponding domain descriptions 568 may be stored in the model database 598. The plurality of domains 564 and their corresponding domain descriptions 568 may also be provided to the topic modeling engine 570.

The example process flow 500 continues with the topic modeling engine 570 identifying, for each respective domain of the plurality of domains 564, a plurality of topics associated with the respective domain. Specifically, the topic modeling engine 570 may obtain, for each respective domain of the plurality of domains 564, at least one of the textual representations (e.g., from the user database 510) or the numerical embeddings (e.g., from the vector database 530) representative of the user data associated with the respective domain (e.g., the corresponding activity 516 and/or vectors 524). Thereafter, the topic modeling engine 570 may identify subgroups of the textual representations or numerical embeddings related to a same subtopic within each respective domain. To note, while the textual representations 548 may be generated for the vector clusters 544 based on a most relevant subset of the activity 516 (e.g., such as to refrain from exceeding a context limit of the LM 560), the topic modeling engine 570 may use an entirety of the associated activity data 516 in identifying the plurality of topics 574 for a given domain. It will be appreciated that identifying narrower subtopics within a broader domain requires a more nuanced and comprehensive analysis. Accordingly, for domains associated with relatively smaller data sets, the topic modeling engine 570 may use the LM 560 to identify the plurality of topics 574 corresponding to the relatively smaller data set. By contrast, for domains associated with relatively larger data sets (e.g., that may exceed a context limit of the LM 560), the topic modeling engine 570 may instead use a slim transformer model and/or a clustering engine to identify the plurality of topics 574 corresponding to the relatively larger data set. As a non-limiting example, the plurality of topics 574 may be identified for each vector cluster 544 using BERTopic or another suitable topic modeling engine configured to extract topics from a list of texts. As another non-limiting example, for domains associated with relatively simple data sets, a word count module may be used to count the number of words within the corresponding cluster and to rank the counted words by popularity (e.g., where stop words ( “is,” “the,” “they,” etc.) are removed), and the plurality of topics for the domain may be determined based on the rankings. Upon identifying the subtopics for each domain, the topic modeling engine 570 may assign, to each subgroup identified for each respective domain, at least one of a description or an ID generated for the subgroup. In these and other manners, the topic modeling engine 570 identifies, for each of the plurality of domains 564, a plurality of topics 574 along with corresponding topic descriptions 578. The plurality of topics 574 and topic descriptions 578 may be stored in a topic database, such as the topic database 430 described with respect to FIG. 4. The plurality of topics 574 and topic descriptions 578 may also be stored in the model database 598. The plurality of topics 574 and topic descriptions 578 may also be provided to the aggregation engine 580, along with relevant user activity 516 from the user database 510. In some instances, the relevant user activity 516 may be all user activity 516 associated with the corresponding plurality of domains 564 over a selected historical time period 588 (e.g., 4 years).

The example process flow 500 continues with the aggregation engine 580 determining, for each respective one of the plurality of topics 574 within each respective one of the plurality of domains 564, an observed level of success 584 for the user activity 516 related to the respective topic 574 over the historical time period 588. The observed levels of success 584 may be determined based on a success metric 594 (e.g., clickthrough rate (CTR), conversion rate) intelligently selected for each respective domain 564, such as in the manners described with respect to the success metric 438 of FIG. 4. In some non-limiting examples, intelligently selecting a success metric 594 for a given one of the plurality of domains 564 may incorporate one or more aspects of, for example, at least one of an automated metric selection technique (e.g., in conjunction with the LM 170), a Bayesian optimization technique, a reinforcement learning technique, or the like.

The example process flow 500 continues with the aggregation engine 580 generating, for each respective topic 574 within each domain 564, an aggregated (e.g., once per observed week) success rate time-series dataset 592 based on the observed levels of success. Specifically, the aggregation engine 580 performs, for each respective domain, a time-series analysis of the observed levels of success 584 for the topics identified within the respective domain, over the historical time period 588, based on the success metric 594 selected for the respective domain. It will be appreciated that the time-series data sets generated for a subset of the topics 574 corresponding to a given one of the domains 564 will correlate with one another because the subset of topics 574 is extracted from a same one of the vector clusters 544 (i.e., the one of the vector clusters 544 that corresponds to the given one of the domains 564). Furthermore, it will be appreciated that each aggregation of the topics 574 is derived from a consolidated contribution of multiple users, and thus represents the success metric selected for the corresponding domain at each discrete time step. In some implementations, each time-series analysis may incorporate one or more aspects of, for example, at least one of a classical time-series modeling technique (e.g., autoregressive integrated moving average (ARIMA), exponential smoothing, seasonal-trend decomposition (STL)), a spectral analysis technique, a Fourier transform technique, a statistical anomaly detection technique, or another suitable trend analysis technique. The success metric 594 selected for each respective domain (and corresponding set of topics) may be stored in association with the aggregated success rate time-series datasets 592 generated for the respective domain.

The example process flow 500 continues with training, using the aggregated success rate time-series datasets 592 in conjunction with a deep learning (DL) technique, a plurality of models to predict trends within a different one of the plurality of domains 564. In other words, a number of the trained models is equal to a number of the plurality of domains 564, where each trained model includes multiple correlated time-series for each topic identified within the corresponding domain. In some aspects, each trained model is a probabilistic forecasting neural network. In various implementations, the DL technique incorporates one or more aspects of at least one of DeepAR or recurrent neural networks (RNNs). For instance, a DeepAR technique (or another suitable predictive engine, forecasting engine, probabilistic engine, time-series engine, or autoregressive RNN model trained on a large number of related time series) may be used in predicting and modeling the correlated time series data based on learning relationships between them simultaneously. DeepAR is particularly advantageous because it is configured to identify trends, observe seasonality, and detect cyclic behavior in data, such as by using an autoregressive (AR) long short-term memory network (LSTM) technique to capture intricate temporal dependencies within individual series while learning shared patterns across related series, thereby allowing the model to generalize from multiple time series and effectively forecast in connection with new or sparsely observed series. In various aspects, training the models using the DL techniques incorporates one or more aspects of, for example, at least one of a backpropagation optimization technique (e.g., using an optimizer such as Adam, root mean squared propagation (RMSprop), stochastic gradient descent (SGD), or the like), a regularization technique (e.g., dropout, batch normalization, early stopping, or the like), or a hyperparameter tuning technique (e.g., grid search, random search, Bayesian optimization, or the like).

The example process flow 500 continues with storing each trained model in the model database 598. Furthermore, each stored model may be associated, in the model database 598, with its corresponding one of the plurality of domains 564 (and its domain description 568), the corresponding ones of the plurality of topics 574 (and their topic descriptions 578), and the corresponding ones of the aggregated success rate time-series datasets 592 (and their associated success metric 594). In this manner, such information may be available during real-time inferencing, such as in the examples described with respect to FIGS. 2–4.

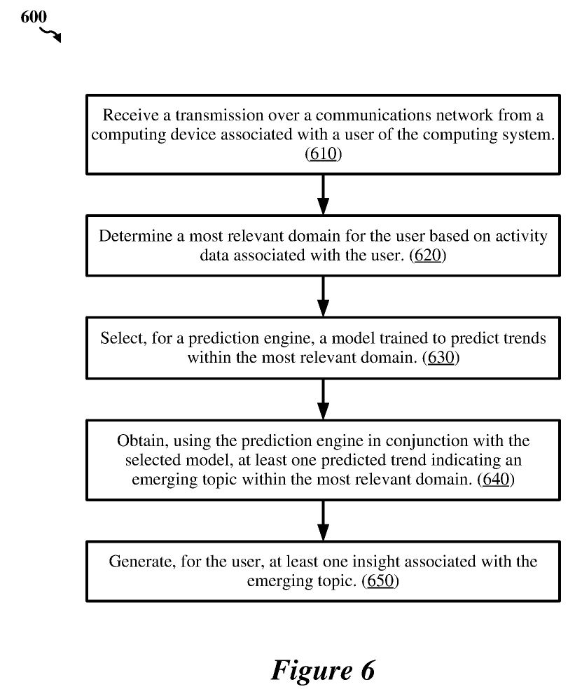

FIG. 6 shows an illustrative flowchart 600 depicting an example operation for predicting emerging topics, according to some implementations, and may be performed by one or more processors of a computing system, such as the computing system 100 described with respect to FIG. 1. For example, at block 610, the computing system 100 receives a transmission over a communications network from a computing device associated with a user of the computing system. At block 620, the computing system 100 determines a most relevant domain for the user based on activity data associated with the user. At block 630, the computing system 100 selects, for a prediction engine, a model trained to predict trends within the most relevant domain. At block 640, the computing system 100 obtains, using the prediction engine in conjunction with the selected model, at least one predicted trend indicating an emerging topic within the most relevant domain. At block 650, the computing system 100 generates, for the user, at least one insight associated with the emerging topic.

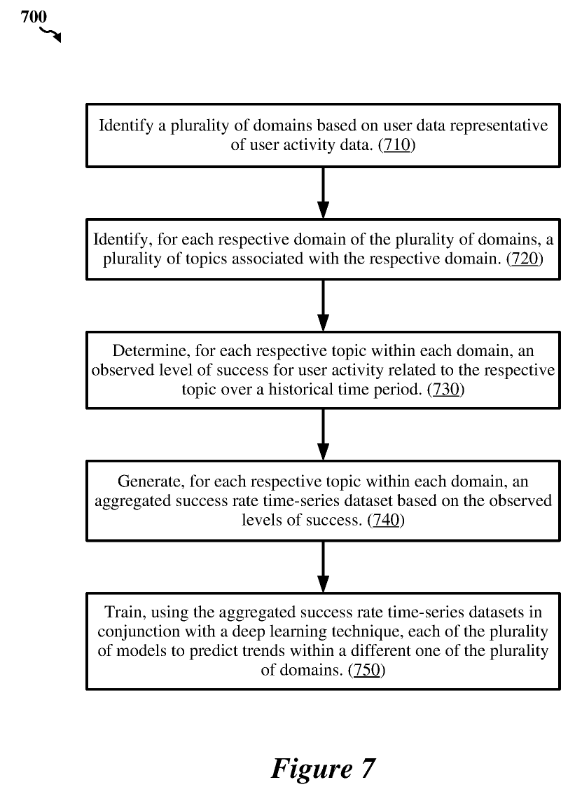

FIG. 7 shows an illustrative flowchart 700 depicting an example operation for training a model, according to some implementations, and may be performed by one or more processors of a computing system, such as the computing system 100 described with respect to FIG. 1. For example, at block 710, the computing system 100 identifies a plurality of domains based on user data representative of user activity data. At block 720, the computing system 100 identifies, for each respective domain of the plurality of domains, a plurality of topics associated with the respective domain. At block 730, the computing system 100 determines, for each respective topic within each domain, an observed level of success for user activity related to the respective topic over a historical time period. At block 740, the computing system 100 generates, for each respective topic within each domain, an aggregated success rate time-series dataset based on the observed levels of success. At block 750, the computing system 100 trains, using the aggregated success rate time-series datasets in conjunction with a deep learning technique, each of the plurality of models to predict trends within a different one of the plurality of domains.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described, in terms of functionality, and illustrated in the various illustrative components, blocks, modules, circuits and processes described above. Whether such functionality is implemented in hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for predicting emerging topics, the method performed by one or more processors of a computing system and comprising:
receiving a transmission over a communications network from a computing device associated with a user of the computing system;
determining a most relevant domain for the user based on activity data associated with the user;
selecting, for a prediction engine, a model trained to predict trends within the most relevant domain;
obtaining, using the prediction engine in conjunction with the selected model, at least one predicted trend indicating an emerging topic within the most relevant domain; and
generating, for the user, at least one insight associated with the emerging topic.

2. The method of claim 1, wherein the activity data is retrieved from a user database responsive to receiving the transmission.

3. The method of claim 1, wherein the most relevant domain is identified based on a portion of the activity data associated with a recent time period.

4. The method of claim 1, wherein determining the most relevant domain for the user includes:
identifying a subset of most relevant domains of a plurality of domains based on the activity data; and
determining which of the subset of most relevant domains appears most frequently within the user’s activity data.

5. The method of claim 4, wherein identifying the subset of most relevant domains includes:
vectorizing the user’s activity data;
identifying, in a vector database including a plurality of topic clusters, a subset of the topic clusters that are most similar to the vectorized activity data; and
identifying the subset of most relevant domains based on text descriptions of the subset of topic clusters.

6. The method of claim 5, wherein identifying the subset of topic clusters is based on a technique incorporating at least one of a similarity metric, a cosine similarity, a Euclidean distance, a k nearest neighbor, a centroid, a similarity threshold, or an approximate nearest neighbor (ANN).

7. The method of claim 1, wherein the transmission includes a user request, and wherein the most relevant domain is determined further based on a context of the user request.

8. The method of claim 1, wherein determining the most relevant domain for the user includes:
feeding the user’s activity data and a plurality of domains to a language model (LM); and
prompting the LM to select the most relevant domain from the plurality of domains based on the user’s activity data.

9. The method of claim 1, wherein the transmission includes a user request, and wherein the at least one predicted trend is generated further based on a time period indicated in the user request.

10. The method of claim 1, wherein the prediction engine generates the at least one predicted trend based on:
predicting, for each of a plurality of topics associated with the most relevant domain, a level of success for the topic during a future time period; and
identifying a subset of emerging topics among the plurality of topics based on the predicted levels of success, wherein each of the emerging topics is associated with at least one of a predicted level of success greater than a threshold or a highest predicted level of success.

11. The method of claim 10, wherein the level of success is predicted based on a time-series analysis of a success metric applicable to the most relevant domain.

12. The method of claim 1, wherein the at least one insight includes a suggestion for the user to pursue activity related to the emerging topic.

13. The method of claim 1, further comprising:
outputting the at least one insight to the user.

14. The method of claim 13, wherein the at least one insight is output to the user in at least near real-time with receiving the transmission.

15. The method of claim 1, wherein the selected model is one of a plurality of models that are each compatible with the prediction engine and trained to predict trends within a different domain.

16. The method of claim 15, wherein training the plurality of models includes:
identifying a plurality of domains based on user data representative of user activity, wherein the most relevant domain is one of the plurality of domains;
identifying, for each respective domain of the plurality of domains, a plurality of topics associated with the respective domain;
determining, for each respective topic within each domain, an observed level of success for user activity related to the respective topic over a historical time period;
generating, for each respective topic within each domain, an aggregated success rate time-series dataset based on the observed levels of success; and
training, using the aggregated success rate time-series datasets in conjunction with a deep learning technique, each of the plurality of models to predict trends within a different one of the plurality of domains.

17. The method of claim 16, wherein identifying the plurality of domains includes:
retrieving the user data from a user database;
transforming, using a transformation engine, the user data into a plurality of vectors;
storing the plurality of vectors in a vector database;
identifying, using a clustering engine, a plurality of clusters of vectors in the vector database; and
determining, for each of the clusters, a domain associated with the user data from which the corresponding vectors were transformed.

18. The method of claim 16, wherein identifying the plurality of topics includes:
obtaining, for each respective domain, at least one of textual representations or numerical embeddings representative of the user data associated with the respective domain;
identifying, using a topic modeling engine, subgroups of the textual representations or numerical embeddings related to a same subtopic within each respective domain; and
assigning, to each subgroup identified for each respective domain, at least one of a description or an ID generated for the subgroup.

19. The method of claim 16, wherein generating the aggregated success rate time-series datasets includes, for each respective topic:
performing, using an aggregation engine, a time-series analysis of the observed levels of success over the historical time period based on a success metric applicable to the domain associated with the respective topic.

20. A computing system for predicting emerging topics, the computing system comprising:
one or more processors; and
at least one memory coupled to the one or more processors and storing instructions that, when executed by the one or more processors, cause the computing system to perform operations including:
receiving a transmission over a communications network from a computing device associated with a user of the computing system;
determining a most relevant domain for the user based on activity data associated with the user;
selecting, for a prediction engine, a model trained to predict trends within the most relevant domain;
obtaining, using the prediction engine in conjunction with the selected model, at least one predicted trend indicating an emerging topic within the most relevant domain; and
generating, for the user, at least one insight associated with the emerging topic.
